(19) United States
(12) Patent Application Publication
(10) Pub. No.: US 2018/0223227 A1
(43) Pub. Date: Aug. 9, 2018

(54) Composition For Solubilization Of Organic Residues

(71) Applicant: Oleon NV, Evergem (BE)

(72) Inventors: Sébastien Barreau, Noyon (FR); Marine Fouquet, La Varenne Saint Hilaire (FR); Christophe Brige, RIBECOURT DRESLINCOURT (FR)

(21) Appl. No.: 15/749,346

(22) PCT Filed: Aug. 1, 2016
(86) PCT No.: PCT/EP2016/068323

§ 371 Date: Jan. 31, 2018

(30) Foreign Application Priority Data
Jul. 31, 2015 (FR) FR1557410

(51) Int. Cl. C11D 11/00; C11D 7/26; C10G 1/04; C11D 1/66

(52) U.S. Cl. CPC C11D 11/0041; C11D 7/266; C10G 1/042; C11D 1/667; C10G 2300/1085; C10G 2300/80; C10G 2300/1077; C10G 2400/16; C10G 2300/107

(57) ABSTRACT

Composition for solubilization of organic residues of raw materials of fossil origin including a mixture of fatty acid esters of formula R1COOR2 in which R1 represents a linear or branched C5 to C23 carbon-based chain, optionally including one or more unsaturations, R2 represents a linear or branched C1 to C10 carbon-based chain, optionally including one or more unsaturations; the composition includes: a) at least 18% by weight of C6 to C10 fatty acid esters, b) at least 18% by weight of C18 to C24, in particular C18 to C22 fatty acid esters, including at least one double bond. The invention also relates to the use of the compositions.

### FIELD OF THE INVENTION

The present invention relates to a composition that can be used to dissolve or disperse organic residues originating from crude oil and in particular paraffin waxes and asphaltenes. It also relates to the uses of such a composition, and to formulations containing such a composition in combination with other excipients.

### BACKGROUND OF THE INVENTION

The solubilization of residues of raw materials of fossil origin is of predominant interest in the oil extraction field. This is because this extraction requires drilling in order to reach the oil deposit, and the crude oil is then recovered through tubes; either it rises naturally by virtue of the pressure of the oil at the beginning of the life of the well, or it rises by means of a pump. It is then conveyed, by oil pipelines, to the refining site.

Throughout the extraction and refining processes, deposits of paraffins or of similar products can accumulate in the production and storage devices, thus limiting the yield.

Moreover, during the use of oil fractionation products, in particular in the road surfacing field, it may be desirable to fluidize the bitumen in order to facilitate mixing with the bituminous mixes and/or spreading thereof.

In general, the various crude oil fractionation products must be able to be eliminated at the time of their use, in a cleaning or stripping step.

Chemical products which are themselves of petroleum origin, such as volatile organic compounds and toxic solvents, are conventionally used for this purpose.

However, these products can have harmful effects on human or animal health, and on the environment.

US 2014/0328625 proposes using fluidizing agents for bitumens comprising C₆-C₁₄ methyl esters, originating in particular from palm oil.

EP 1 012 211 describes stripping agents based on lower-alkyl esters of fatty acid having from 6 to 22 carbon atoms, mixed with solvents such as hydrocarbons or DMSO.

### SUMMARY OF THE INVENTION

It remains desirable to be able to have compositions which have good solvent or dispersant properties for raw materials which come from the fractionation of heavy oils, but which are derived from renewable raw material and do not have harmful effects of this type.

It is also desirable to have compositions which are not readily inflammable, so as to be able to transport them without any particular precaution and to use them under temperature conditions that are compatible with oil plants for example.

It is in addition desirable for the compositions to also have a satisfactory fluidity.

These objectives and others are achieved by means of the present invention.

The subject of the present invention is a composition for solubilization of organic residues of raw materials of fossil origin comprising a mixture of fatty acid esters of formula:

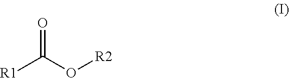

in which

R1 represents a linear or branched C₅ to C₂₃, in particular C₅ to C₂₁, and especially C₅ to C₁₉, carbon-based chain, optionally comprising one or more unsaturations,

R2 represents a linear or branched C₁ to C₁₀ carbon-based chain, optionally comprising one or more unsaturations;

said composition comprising:

a) at least 18% by weight of C₆ to C₁₀ fatty acid esters,

b) at least 18% by weight of C₁₈ to C₂₄, in particular C₁₈ to C₂₂, fatty acid esters comprising at least one unsaturation, in particular at least one double bond, and

on the condition that the content of C₈ to C₁₄ saturated fatty acid esters is greater than or equal to 38% by weight, the weight percentages being given relative to the total weight of fatty acid esters in the composition.

Preferably, R1 represents a linear carbon-based chain.

Preferably, R2 represents a saturated, in particular C₁ to C₈, carbon-based chain.

It is understood that, for at least one part of the fatty acid esters present in the composition, in formula (I) at least one of the R1 or R2 chains comprises at least one unsaturation, in particular at least R1 comprises at least one unsaturation.

According to one advantageous embodiment, the mixture comprises fatty acid esters for which R1 represents a C₅ to C₂₃ carbon-based chain as defined above, comprising one or more unsaturations, and fatty acid esters for which R1 represents a C₅ to C₂₃ carbon-based chain as defined above, not comprising an unsaturation.

The term “at least one unsaturation” is intended to mean in particular at least one double bond or at least one triple bond.

The fatty acid esters mentioned in a are in particular C₈ to C₁₀ fatty acid esters. Methyl or ethyl esters, in particular methyl esters, are for example used.

The fatty acid esters mentioned in b are in particular esters of C₁₈ fatty acids comprising at least one unsaturation, such as C_{18:1} fatty acids, C_{18:2} fatty acids and mixtures thereof in any proportions.

Advantageously, in the composition for solubilization of organic residues of raw materials of fossil origin according to the invention, among the at least 18% by weight of C₁₈ to C₂₄ fatty acid esters comprising at least one unsaturation, and in particular comprising at least one double bond, at least 10% by weight, and in particular at least 12% by weight, are C_{18:1} fatty acid esters, the weight percentages being given relative to the total weight of fatty acid esters in the composition.

The fatty acid esters originate either from a fatty acid esterification, or from a triglyceride transesterification.

The fatty acids and the triglycerides advantageously come from renewable resources, such as plant oils and plant and animal fats.

A particular fraction of fatty acids or of fatty esters, such as of C₆-C₁₀ and C₈-C₁₀, is obtained by any method known to those skilled in the art, in particular by distillation of a mixture of fatty acids or of fatty esters.

The C₆ to C₁₀ fatty acids are preferably saturated. These fatty acids may in particular be chosen from hexanoic acid, caprylic acid, capric acid, pelargonic acid and mixtures thereof in any proportions.

The C₈-C₁₀ fatty acids are preferably saturated fatty acids; they may in particular be chosen from caprylic acid, capric acid, pelargonic acid and mixtures thereof in any proportions. In particular, a mixture of esters of caprylic acid and of capric acid, in particular a mixture of methyl esters comprising 45% to 70% of caprylate and from 30% to 55% of caprate, is used.

Such fatty acid ester fractions can in particular be obtained from coconut oil and/or from palm kernel oil, advantageously from coconut oil.

The C₈ to C₁₄ fatty acid esters may in particular be chosen from caprylic acid, capric acid, perlargonic acid, lauric acid, myristic acid and mixtures thereof in any proportions. They can be introduced into the composition according to the invention via a particular fraction obtained from coconut oil, from palm kernel oil, from tallow and/or from fish oil, or via one of these plant/animal oils/fats that has been transesterified.

Advantageously, the C₈ to C₁₄ fatty acid esters are introduced into the composition according to the invention via a transesterified coconut oil or a transesterified palm kernel oil.

It is thus possible to prepare compositions containing methyl, ethyl, isopropyl, butyl, isoamyl or 2-ethylhexyl esters of coconut oil and of palm kernel oil.

In particular, the C₈ to C₁₄ fatty acid esters are esters of coconut oil.

The invention thus relates to compositions comprising esters of coconut oil fatty acids and of C₁ to C₈ alcohols, at a concentration of 0 to 60% by weight.

Advantageously, the total concentration of esters, in particular of methyl esters of C₈ to C₁₀ fatty acids and of coconut oil fatty acid esters is greater than or equal to 35% of the total composition of fatty acid esters, and less than or equal to 85%, preferably less than or equal to 80%.

### DETAILED DESCRIPTION OF THE INVENTION

A subject of the present invention is thus a composition for solubilization of organic residues of raw materials of fossil origin, comprising a mixture of fatty acid esters, characterized in that the mixture of fatty acid esters comprises a mixture of compounds of formula:

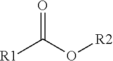

in which

R1 represents a linear or branched C₅ to C₂₃, in particular C₅ to C₂₁, and especially C₅ to C₁₉, carbon-based chain, optionally comprising one or more unsaturations,

R2 represents a linear or branched C₁ to C₁₀ carbon-based chain, optionally comprising one or more unsaturations;

said composition comprising:

a) at least 18% by weight of C₈ to C₁₀ fatty acid esters, in particular of methyl esters or ethyl esters of C₈ to C₁₀ fatty acids,

b) at least 18% by weight of C₁₈ to C₂₄, in particular C₁₈ to C₂₂, fatty acid esters, comprising at least one double bond, and

c) optionally, esters of fatty acids of coconut oil and of C₁ to C₈ alcohols, at a concentration of 0 to 60% by weight,

the total concentration of C₈ to C₁₀ fatty acid esters and of esters of fatty acids of coconut oil being greater than or equal to 35% of the total composition of fatty acid esters, and less than or equal to 85%, preferably less than or equal to 80%.

Unless otherwise specified, the concentrations are expressed throughout the present text by weight, relative to the total weight of the composition.

Advantageously, when the concentration of C₈ to C₁₀ fatty acid esters is less than or equal to 25%, or even less than or equal to 21%, the concentration of esters of fatty acids of coconut oil is greater than or equal to 25%, in particular greater than or equal to 30%.

The C_{18:2} fatty acid esters are in particular linoleic acid esters.

The C_{1:18} fatty acids may be chosen from the group comprising oleic acid, vaccenic acid and ricinoleic acid; preferably, the C_{18:1} fatty acid ester(s) present in the compositions according to the invention are chosen from oleic acid esters.

Such esters can in particular be obtained by esterification or transesterification of fatty acids of rapeseed oil, this oil possibly comprising up to 65% of oleic acid. The C_{18:1} fatty acid esters can also, in a manner known per se, be obtained from olive oil or avocado oil.

These esters can also be obtained from other oils of plant or animal origin that can contain at least 20% of oleic acid, such as: palm, peanut, corn, soya bean, sunflower, grapeseed, linseed, rosin, tallow or animal fat.

According to one of the embodiments of the invention, the oleic acid ester is introduced into the composition in the form of rapeseed oil ester.

A subject of the invention is thus also a composition for solubilization of organic residues of raw materials of fossil origin as described above, comprising a mixture of fatty acid esters of formula:

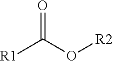

in which

R1 represents a linear or branched C₅ to C₂₃, in particular C₁₇ to C₂₁, carbon-based chain, optionally comprising one or more unsaturations,

R2 represents a linear or branched C₁ to C₁₀ carbon-based chain, optionally comprising one or more unsaturations;

said composition comprising:

a) at least 18% by weight of methyl esters of C₈ to C₁₀ fatty acids,

b) at least 20% by weight of esters of fatty acids of rapeseed oil, and

c) optionally, esters of fatty acids of coconut oil and of C₁ to C₈ alcohols, at a concentration of 0 to 60% by weight,

the total concentration of methyl esters of C₈ to C₁₀ fatty acids and of esters of fatty acids of coconut oil being greater than or equal to 35%, in particular greater than or equal to 40% of the total composition, and less than or equal to 85%.

The coconut oil esters (or cocoate) will comprise a mixture of esters of lauric, myristic, caprylic, capric, oleic, linoleic, stearic and palmitic acid.

It has been found, unexpectedly, that compositions corresponding to the characteristics above, that can be prepared from renewable raw materials, namely plant or animal raw materials, preferably plant raw materials, have very good properties of dissolution and dispersion of paraffin waxes and by-products of petroleum fractionation and distillation, this being in wide temperature ranges. Generally, starting from 35° C., 70% of the organic residues are dissolved.

In addition, these compositions are neither inflammable nor combustible, as emerges from the measurement of their flashpoint. Finally, the compositions according to the invention remain liquid at low temperatures, this property being objectivized by measuring their pour point.

The pour point of a product is the temperature at which the product no longer pours.

Generally, the compositions in accordance with the invention have a pour point below −20° C.

The flash point is the minimum temperature for which the concentration of vapors given off is sufficient to produce a deflagration in contact with a flame or with a hot point under standardized conditions, but insufficient to produce propagation of the combustion in the absence of the “pilot” flame.

A minimum temperature at which the emission of vapors is sufficient to form with air the gas mixture that is inflammable under the external action of a flame is demonstrated.

This minimum temperature level is called the flash point.

The lower the flash point, the more inflammable and therefore the more dangerous the substance is.

A second level, above the flash point, called the fire point, which is necessary and sufficient for the combustion of the gas mixture to be maintained and to endure, is noted.

It should be noted that this fire can take place under the action of an external source (flame) or can be spontaneous, reference is then made to auto-ignition point.

Standards define the various measurement protocols: they may be open cup tests (for example: Pensky-Martens, Abel, Miniflash, Tag) or closed cup tests (Cleveland). In the context of the invention, the measurements are carried out according to ASTM standard D92, which corresponds to an open cup test (Cleveland).

The compositions according to the invention have a flash point greater than 80° C., in particular greater than or equal to 90° C., advantageously greater than or equal to 93° C., in particular greater than or equal to 95° C., or even greater than or equal to 100° C.

According to one variant of the invention, the composition contains at least 12% by weight of C_{18:1} fatty acid esters, in particular at least 15%, especially at least 18%.

According to one advantageous embodiment, the sum of the concentrations of methyl esters of C₈ to C₁₀ fatty acids and of the C_{18:1} fatty ester(s) is greater than or equal to 40%, especially greater than or equal to 45%, in particular greater than or equal to 50%.

Compositions which particularly correspond to the objectives of the invention are those for which the C_{1:18} fatty acid esters are alcohol esters for which R2 represents a C₁-C₈, in particular C₁-C₅, more particularly C₁-C₄, carbon-based chain.

It may in particular be a methyl, ethyl, propyl, isopropyl, butyl, pentyl or isoamyl ester, or mixtures thereof, in particular esters formed with oleic acid.

It is thus possible to prepare compositions containing methyl, butyl or isoamyl esters of rapeseed oil, in particular methyl esters of rapeseed oil. According to one of the embodiments of the invention, the C_{18:1} fatty acid esters present in the composition are chosen from n-butyl oleate, methyl oleate and mixtures thereof; the methyl oleate can be introduced into the composition in the form of methyl esters of rapeseed oil.

Moreover, the fatty acid esters mentioned in c) are advantageously chosen from methyl cocoate, 2-ethylhexyl cocoate and mixtures thereof in any proportions, preferably the fatty acid esters mentioned in c) are esters of coconut oil and of 2-ethylhexanol, also called 2-ethylhexyl cocoate.

According to a further variant of the invention, the solubilization composition contains at least 36% of methyl esters of C₈ to C₁₀ fatty acids.

Thus, a composition that is particularly suitable for implementation of the invention contains a mixture of fatty acids consisting of:
a) 36% to 43% of methyl esters of C₈ to C₁₀ fatty acids,
b) at least 18% of C_{18:1} fatty acid esters chosen from methyl esters, ethyl esters, butyl esters, isoamyl esters, 2-ethylhexyl esters and mixtures thereof, in particular from methyl esters, butyl esters and mixtures thereof.

Such compositions will advantageously comprise a concentration of methyl esters of rapeseed oil of greater than or equal to 30%.

In particular, the composition may comprise:
a) 40% of methyl esters of a mixture of fatty acids comprising from 78% to 100% of C₈ and C₁₀ saturated fatty acids,
b) 30% of methyl or ethyl esters of rapeseed oil and 30% of a composition containing at least 68% of n-butyl oleate.

According to another embodiment of the invention, the solubilization composition contains:
a) 40% of methyl esters of a mixture of fatty acids comprising from 78% to 100% of C₈ and C₁₀ saturated fatty acids,
b) 30% of methyl or ethyl esters of rapeseed oil,
c) 30% of 2-ethylhexyl cocoate.

The compositions according to any one of the embodiments according to the invention may be used pure, or as a mixture with a solvent. The solvent may in particular be chosen from xylene or mineral oils.

The compositions according to any one of the embodiments of the invention can be used to solubilize or disperse solid bitumens, in particular heavy oils, such as paraffins and paraffin waxes or asphaltenes.

The term “paraffin” is intended to mean saturated hydrocarbons of formula CₙH₂ₙ₊₂ with n ranging from 8 to 40. In paraffin waxes, n is generally greater than or equal to 20.

The compositions according to any one of the embodiments of the invention may be used to strip or maintain facilities for extraction, refining, transportation and storage of petroleum and derivatives thereof.

They will also be used for cleaning and stripping any type of device in contact with petroleum derivatives of paraffin or asphaltene type, in particular for the degreasing of metal parts in industry or of printing presses.

The compositions according to any one of the embodiments according to the invention can also be used in the paint field, for example as a diluent or binder in paints, or for cleaning surfaces or tools after use.

The compositions according to any one of the embodiments according to the invention will also be used in the construction industry, as a concrete demolding agent.

A composition according to the invention can also be used in the road surfacing field, in bituminous binders, for fluidizing the bituminous composition. The composition acts as a flux and facilitates the spreading of the bitumen and the coating of the minerals contained in the bituminous composition.

All these uses of the compositions and formulations are also included in the invention.

A subject of the invention is also a process for preparing a composition for solubilization of organic residues of raw materials of fossil origin, comprising the following mixture of fatty acid esters:
a) at least 20% by weight of a mixture comprising at least 90% of C₆ to C₁₀ saturated fatty acid esters, in particular of methyl esters of C₈ to C₁₀ fatty acids,
b) at least 15% by weight of C₁₈ to C₂₄, in particular C₁₈ to C₂₂, fatty acid esters comprising at least one double bond, and
c) optionally, esters of fatty acids of coconut oil and of C₁ to C₈ alcohols, at a concentration of 0 to 60% by weight.

In particular, at least 20% of a mixture of methyl esters of fatty acids comprising from 48% to 70% of C₈ (caprylate) methyl ester, from 30% to 50% of C₁₀ (caprate) methyl ester, an amount of less than or equal to 4.5% of C₆ methyl ester, and an amount of less than or equal to 2% of C₁₂ methyl esters is mixed with the constituents b) and c), as defined in the aforementioned.

Other characteristics and advantages of the invention will emerge on reading the examples which follow.

### EXAMPLE 1

### Preparation of Compositions According to the Invention

Use is made of the composition of methyl ester of rapeseed oil which has the following composition:
C_{16:0} 4.3%
C_{18:1} 62-63.5%
C_{18:2} 19.1-19.3%
C_{018:3} 9.1-9.7%

The mixture of C₈/C₁₀ methyl esters (Methyl C₈/C₁₀) which has the following composition:
C₆: less than or equal to 4.5%
C₈: 48-70%
C₁₀: 30-50%
C₁₂: less than or equal to 2%

The n-butyl oleate composition corresponds to a mixture comprising from 68% to 92% of n-butyl oleate, at least 8% of butyl ester of linoleic acid, and from 0 to 2% of butyl ester of linolenic acid, the remainder consisting, as appropriate, of C₁₆ and C₁₈ saturated fatty acid ester.

The various constituents of the formulations are mixed in a container at ambient temperature until homogenization of the formulation.

| | | | Ethyl | | |
|---|---|---|---|---|---|
| | | | esters of | n-Butyl | 2-Ethyl- |
| | Methyl | Methyl | rapeseed | oleate | hexyl |
| Formulation | C₈/C₁₀ | cocoate | oil | composition | cocoate |
| Form. 4X | 40% | | 30% | 30% | |
| Form. 5 bisX | 30% | 10% | 30% | | 30% |
| Form. 8X | 20% | | 30% | 20% | 30% |

The flash point and the pour point of the formulations are determined by the methods according to standards ASTM D92 and ASTM D97, respectively.

Characteristics of the formulations

| | Form. 4X | Form. 5 bisX | Form. 8X |
|---|---|---|---|
| Viscosity at | 3.0 | 3.0 | 3.8 |
| 40° C. (mm²/s) | | | |
| Flash point (° C.) | 100 | 104 | 116 |
| Fire point (° C.) | 106 | 114 | 128 |
| Pour point (° C.) | −21 | −24 | −21 |
| Density at | 0.8733 | 0.8709 | 0.8699 |
| 20° C. (g · cm⁻³) | | | |

Other formulations are prepared in the same way, with the following compositions:

| | | | Ethyl | | |
|---|---|---|---|---|---|
| | | | esters of | n-Butyl | 2-Ethyl- |
| | Methyl | Methyl | rapeseed | oleate | hexyl |
| | C₈/C₁₀ | cocoate | oil | composition | cocoate |
| Comparative | 30% | | 40% | 30% | |
| example 1 | | | | | |
| Comparative | | | 50% | | 50% |
| example 2 | | | | | |

The pour points are measured.

The formulation of comparative example 1, for which the total concentration of Methyl C₈/C₁₀ and of esters of fatty acids of coconut oil is equal to 30%, has a pour point above −20° C., and is not therefore suitable for implementation of the invention. The content of C₈ to C₁₄ fatty acid esters of this composition is less than 38% by weight required for the compositions according to the invention.

The formulations 4×, 5bis× and 8× all have a pour point below or equal to −20° C. and a flash point greater than or equal to 100° C.

### EXAMPLE 2

### Tests for Determining the Dissolution Temperature

The tests are carried out with solid organic residues originating from oil fields of tar sands.

Method/Procedure:

Approximately 1 g of paraffin wax is placed in 100 ml of solvent, in a glass container, with magnetic stirring (140 rpm). The container is gradually heated in a water bath from ambient temperature up to the temperature with complete dissolution of the residues introduced. The temperature of the test is maintained for approximately 15 min before being increased by 5° C., up to the dissolution temperature.

Results:

The dissolution temperatures for the waxes in the formulations tested are:

to have dissolution >70%: between 30 and 40° C. depending on the type of wax

to have total dissolution: between 40° C. and 45° C. depending on the type of wax.

Under the conditions tested, the temperatures for total dissolution of xylene and of cyclohexane are between 30 and 35° C.

### EXAMPLE 3

### Tests for the Limiting Dissolution of Organic Residues

The tests are carried out with solid organic residues originating from oil fields of tar sands.

The test is based on the Baker Petrolite method: (Experimental solubility data of various n-alkane waxes: effects of alkane chain length, alkane odd versus even carbon number structures and solvent chemistry on solubility) D. W. Jennings, K. Weispfennig/Fluid Phase Equilibria 227 (2005) 27-35.

a—Method

100 ml of formulation (to be evaluated) are charged, with magnetic stirring (140 rpm), to a glass container (200 ml). The container is heated to 45° C. in a water bath. At this temperature, 1 g of organic residues is added every 15 min. The dissolution of the wax is determined visually.

Results:

Under these conditions, it was impossible to dissolve approximately 45 g of wax without observing saturation of the solution. Identical results were observed using xylene.

It was observed that the solutions at 45° C. were viscous but homogeneous without apparent deposit. If the ambient temperature is decreased, the solutions become pasty with 6 g to 12 g of wax in the formulation.

b—Method:

100 ml of formulation (or xylene) are charged, with magnetic stirring (140 rpm), to a glass container (200 ml). The container is heated at 40° C. in a water bath, containing a known amount of wax (addition of 1 g of wax at the temperature). After dissolution, a metal spatula is immersed in the solution:

if no residue is observed on the spatula, then the test is continued (an additional weight);

if residue is observed on the spatula, then the test is stopped.

Test 2—Solubility of Wax in Xylene

| | Weight of wax (g) | | | | | |
|---|---|---|---|---|---|---|
| | 14 g | 15 g | 16 g | 17 g | 20 g | 22 g |
| Observations | no | no | slight | slight | slight | deposit |
| (on the | deposit | deposit | deposit | deposit | deposit | on the |
| spatula) | | | | | | spatula |

Test 2—Solubility of Wax in the Formulations

| | Weight of wax (g) | | | | | |
|---|---|---|---|---|---|---|
| | 1 g-2 g | 3 g-4 g | 5 g | 6 g | 8 g | 9 g |
| Form. | no | no | no | deposit | | |
| 4X | deposit | deposit | deposit | on the | | |
| | | | | spatula | | |
| Form. | no | no | no | no | no | deposit |
| 5 bisX | deposit | deposit | deposit | deposit | deposit | on the |
| | | | | | | spatula |
| Form. | no | no | deposit | | | |
| 8X | deposit | deposit | on the | | | |
| | | | spatula | | | |
| Comparative | deposit | | | | | |
| example 2 | on the | | | | | |
| | spatula | | | | | |

The results show that it is possible to solubilize an amount of wax in the fatty acid ester formulations.

On the other hand, it is not possible to solubilize wax in comparative example 2, which does not contain enough C₆ to C₁₀ fatty acid esters. This is because said fatty acid esters can only come from the esters of coconut oil which represent 50% by weight of the formulation. There can therefore be only a maximum of 10% by weight of C₆ to C₁₀ fatty acid esters, in particular a maximum of 9% by weight of 0₈ to C₁₀ fatty acid esters.

c—Method:

In order to have a better idea of the limit of solubility of the waxes, tests are carried out using a paraffin (with a melting point of 44° C.). Specifically, the paraffin is colorless when hot and white when cold. It should thus be easier to observe wax dissolution phenomena.

100 ml of formulation are charged, with magnetic stirring (140 rpm) to a glass container (200 ml). The container is heated to 40° C. in a water bath, containing a known amount of paraffin, until dissolution of the waxes. After cooling to ambient temperature, the solutions are kept for 2 days before carrying out the observations.

Solubility of the Paraffin in the Fatty Acid Formulations

| Weight paraffin (g) | | | | | | |
|---|---|---|---|---|---|---|
| 2 g | 4 g | 5 g | 6 g | 7 g | 8 g | 9 g |

| | | | | |
|---|---|---|---|---|
| Form. | absoutely | slight veil at | cloudy at | |
| 4X | homogeneous | the bottom, de- | the bottom, de- | |
| | | posit with clear | posit with clear | |
| | | upper phase | upper phase | |
| Form. | absolutely | slight veil at | | slight veil at |
| 5X bis | homogeneous | the bottom, de- | | the bottom, de- |
| | | posit with clear | | posit with clear |
| | | upper phase | | upper phase |

| | | | |
|---|---|---|---|
| Form. | absolutely | slight veil at | cloudy at |
| 8X | homogeneous | the bottom, de- | the bottom, de- |
| | | posit with clear | posit with clear |
| | | upper phase | upper phase |

### EXAMPLE 4

### Fluidizing Action of a Composition

Fatty acid ester composition:

40% C₈/C₁₀ methyl esters

30% ethyl esters of rapeseed

30% butyl oleate

The paraffin was purchased from Panreac: Paraffin CAS [8002-74-2] EC number (EINECS): 232-315-6.

The fatty acid ester composition is mixed with the paraffin in various proportions and the mixture is heated to 50° C.-55° C. with magnetic stirring at 200 rpm. The viscosity of the resulting composition is measured with a Stabinger SVM 300/G2 viscometer from Anton Paar.

Kinematic viscosity at 60° C.:

Paraffin alone: 4.8918 mm²/s

Fatty acid ester mixture alone: 2.2072 mm²/s.

Fatty acid ester mixture/paraffin (90/10, w/w): 2.2628 mm²/s

Fatty acid ester mixture/paraffin (85/15, w/w): 2.4182 mm²/s

Conclusion: the fatty acid ester mixture fluidizes the paraffin.

1. A composition for solubilization of organic residues of raw materials of fossil origin, comprising a mixture of fatty acid esters, characterized in that the mixture of fatty acid esters comprises a mixture of compounds of formula 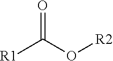
in which
R1 represents a linear or branched C₅ to C₂₃ carbon-based chain,
R2 represents a linear or branched C₁ to C₁₀ carbon-based chain,
said composition comprising:
a) at least 18% by weight of C₆ to C₁₀ fatty acid esters, and
b) at least 18% by weight of C₁₈ to C₂₄, fatty acid esters comprising at least one double bond,
wherein the content of C₈ to C₁₄ saturated fatty acid esters is greater than or equal to 38% by weight, the weight percentages being given relative to the total weight of fatty acid esters in the composition.

2. The composition for solubilization of organic residues of raw materials of fossil origin according to claim 1, characterized in that it comprises esters of fatty acids of coconut oil and of C₁ to C₈ alcohols, at a concentration of 0 to 60% by weight,
the total concentration of C₈ to C₁₀ fatty acid esters and of esters of fatty acids of coconut oil being greater than or equal to 35% of the total composition, and less than or equal to 85%.

3. The composition for solubilization of organic residues of raw materials of fossil origin according to claim 1, wherein, among the at least 18% by weight of C₁₈ to C₂₄ fatty acid esters comprising at least one unsaturation, at least 10% by weight are C_{18:1} fatty acid esters, the weight percentages being given relative to the total weight of fatty acid esters in the composition.

4. The composition according to claim 3, characterized in that the esters of C_{18:1} fatty acids are alcohol esters for which R2 represents a C₁-C₈ carbon-based chain.

5. The composition according to claim 3, characterized in that the esters of C_{18:1} fatty acids are chosen from methyl esters, ethyl esters, propyl esters, isopropyl esters, butyl esters, isoamyl esters and mixtures thereof.

6. The composition according to claim 1, characterized in that the fatty acid esters are chosen from methyl cocoate, 2-ethylhexyl cocoate and mixtures thereof.

7. The composition according to claim 1, characterized in that it has a flash point greater than 90° C. and a pour point below −20° C.

8. The composition according to claim 3, characterized in that the C_{18:1} fatty acid esters are oleic acid esters.

9. The use of a composition according to claim 1, as an agent for cleaning and stripping a device in contact with petroleum derivatives of paraffin or asphaltene type.

10. The use according to claim 9, characterized in that the composition is used as a flux in a bituminous composition.

11. The use of a composition according to claim 1, characterized in that said composition is used as a mixture with at least one solvent chosen from xylene or mineral oils.

12. The composition for solubilization of organic residues of raw materials of fossil origin according to claim 1, wherein R1 comprises one or more unsaturations.

13. The composition for solubilization of organic residues of raw materials of fossil origin according to claim 1, wherein R2 comprises one or more unsaturations.

14. The composition for solubilization of organic residues of raw materials of fossil origin according to claim 1, wherein the at least 18% by weight of C₁₈ to C₂₄ fatty acid esters comprising at least one double bond is a C₁₈ to C₂₂ fatty acid ester.

15. The composition according to claim 4, wherein the esters of C_{18:1} fatty acids are alcohol esters for which R2 represents a C₁-C₅ carbon-based chain.
